(19) United States
(12) Patent Application Publication
(10) Pub. No.: US 2024/0264450 A1
(43) Pub. Date: Aug. 8, 2024

(54) HEAD-MOUNTED DISPLAY

(71) Applicant: Samsung Display Co., LTD., Yongin-si (KR)

(72) Inventors: Ji Won LEE, Yongin-si (KR); Sang Ho KIM, Yongin-si (KR); Soo Min BAEK, Yongin-si (KR); Ju Youn SON, Yongin-si (KR); Cheon Myeong LEE, Yongin-si (KR); Bek Hyun LIM, Yongin-si (KR); Ju Hwa HA, Yongin-si (KR)

(21) Appl. No.: 18/417,740

(22) Filed: Jan. 19, 2024

(30) Foreign Application Priority Data
Feb. 8, 2023 (KR) 10-2023-0016779

(51) Int. Cl. G02B 27/01; G02B 27/00

(52) U.S. Cl. CPC G02B 27/0176; G02B 27/0093; G02B 27/0172; G02B 2027/0138; G02B 2027/0154; G02B 2027/0163; G02B 2027/0198

(57) ABSTRACT

A head-mounted display is provided, and the head-mounted display includes a pair of frames mounted on the user's body and corresponding to the left and right eyes, a display unit including a pair of display panels respectively mounted to the pair of frames and a pair of multi-channel lenses disposed on a light output path of the pair of display panels and a driving member connected to the pair of frames to allow the frame to tilt and/or move up, down, left, and right, wherein the driving member aligns a center of each of the pair of multi-channel lenses up, down, left, and right with the center of the corresponding eyeball, adjusts an angle of the multi-channel lens, and adjusts a distance between the multi-channel lens and an eye.

This application claims priority to Korean Patent Application No. 10-2023-0016779 filed on Feb. 8, 2023, and all the benefits accruing therefrom under 35 U.S.C. 119, the contents of which in its entirety is herein incorporated by reference.

### BACKGROUND

### 1. Field

The present disclosure relates to a head-mounted display.

### 2. Description of the Related Art

The importance of a display device is increasing along with the development of multimedia. In response to this, various types of display devices such as liquid crystal displays (LCD) and organic light emitting displays (OLED) are being used.

Among the display devices, there are electronic devices provided in a form that may be worn on the body of a user. These electronic devices are commonly referred to as wearable electronic devices. The wearable electronic device may be directly worn on the body to improve portability and user accessibility.

As an example of a wearable electronic device, there is a head-mounted display (HMD) (head-mounted electronic device) that may be mounted on the wearer's face or head. HMD may be largely classified into see-through types that provide augmented reality (AR) and see-closed types that provide virtual reality (VR).

### SUMMARY

Aspects and features of embodiments of the disclosure provide a head-mounted display capable of adjusting an optical device and optical characteristics by including a driving member that tilts and/or moves a multi-channel lens up, down, left and right.

In addition, in an embodiment, it is possible to provide a head-mounted display capable of adjusting an optical device and optical characteristics by tracking the position of pupils through a camera, etc., checking the presence and/or absence of glasses of a user, and controlling a driving member.

However, aspects of the disclosure are not restricted to the one set forth herein. The above and other aspects of the disclosure will become more apparent to one of ordinary skill in the art to which the disclosure pertains by referencing the detailed description of the disclosure given below.

According to an embodiment, a head-mounted display includes a pair of frames mounted on the user's body and corresponding to the left and right eyes, a display unit including a pair of display panels respectively mounted to the pair of frames and a pair of multi-channel lenses disposed on a light output path of the pair of display panels and a driving member connected to the pair of frames to allow the frame to tilt and/or move up, down, left, and/or right, wherein the driving member aligns a center of each of the pair of multi-channel lenses up, down, left, and/or right with the center of the corresponding eyeball, adjusts an angle of the multi-channel lens, and/or adjusts a distance between the multi-channel lens and an eye.

In an embodiment, the driving member includes a first driving unit adjusting a distance between the pair of display panels, a second driving unit tilting the disposition direction of the pair of display panels about a central axis and/or adjusting a tilting angle of the pair of display panels, a third driving unit adjusting a distance between the pair of display panels and a pupil and a fourth driving unit capable of vertically moving the pair of display panels.

In an embodiment, the head-mounted display further comprises an eye tracking member including a camera disposed outside the multi-channel lens and installed toward the user's eyes.

In an embodiment, the eye tracking member obtains pupil position information from an image acquired by the camera based on a previously stored eye tracking algorithm.

In an embodiment, the first driving unit includes a pair of plates each fixed to a pair of frames and each having a long-shaped hole at one end in a longitudinal direction, a rotating gear disposed within the long-shaped hole and a driving motor for rotating a rotation gear based on the pupil position information, wherein the long-shaped hole is formed with a linear gear meshing with the rotary gear on one side, wherein the pair of plates is disposed such that each long-shaped hole overlaps at least a portion of each other.

In an embodiment, the second driving unit includes a motor controlling a tilting direction and/or degree of tilting of the pair of display panels based on the pupil position information.

In an embodiment, the third driving unit includes an outer pipe having a hollow inside and a through hole formed through an outer circumferential surface, an inner pipe movably inserted into the outer pipe and a motor controlling a moving direction and/or amount of the inner pipe.

The outer pipe and the inner pipe are disposed in a longitudinal direction parallel to an optical axis of the multi-channel lens.

In an embodiment, the motor controls a moving direction and/or amount of the inner pipe according to whether a user wears glasses.

In an embodiment, the fourth driving unit includes an outer pipe having a hollow inside and a through hole formed through an outer circumferential surface, an inner pipe movably inserted into the outer pipe and a motor for controlling a moving direction and/or a moving amount of an inner pipe based on the pupil position information.

In an embodiment, the outer pipe and the inner pipe of the fourth driving unit are disposed in a longitudinal direction perpendicular to an optical axis of the multi-channel lens.

In an embodiment, the multi-channel lens includes a plurality of sub-lenses, and forms light incident by each sub-lens for each of a plurality of channels.

According to an embodiment, a head-mounted display includes a pair of frames mounted on the user's body and corresponding to the left and right eyes, a display unit including a pair of display panels respectively mounted to the pair of frames and a pair of multi-channel lenses disposed on a light output path of the pair of display panels and an eye tracking member disposed outside the multi-channel lens to obtain pupil position information and a driving member connected to the pair of frames to tilt and/or move the frame up, down, left, and/or right, wherein the driving member adjusts up, down, left, and/or right alignment of a center of each eyeball corresponding to the center of each of the pair of multi-channel lenses, adjusting an angle of the multi-channel lens, and/or adjusting a distance between the multi-channel lens and an eye based on the pupil position information.

In an embodiment, the eye tracking member includes: a light source disposed outside the multi-channel lens and installed in a direction toward the user's eyes; a camera and/or image sensor disposed outside the multi-channel lens and installed in the direction of the user's eyes and detecting light emitted from the light source and reflected in the user's pupil.

In an embodiment, the driving member includes a first driving unit for adjusting a distance between the pair of display panels, wherein the first driving unit includes, a pair of plates each fixed to a pair of frames and each having a long-shaped hole at one end in a longitudinal direction, a rotating gear disposed within the long-shaped hole and a driving motor for rotating a rotation gear based on the pupil position information, wherein the long-shaped hole is formed with a linear gear meshing with the rotary gear on one side, wherein the pair of plates is disposed such that each long-shaped hole overlaps at least a portion of each other.

In an embodiment, the driving member includes a second driving unit tilting a disposition direction of the pair of display panels about a central axis and/or adjusting a tilting angle of the pair of display panels, wherein the second driving unit includes a motor controlling a tilting direction and/or degree of tilting of the pair of display panels based on the pupil position information.

In an embodiment, the driving member includes a third driving unit for adjusting a distance between the pair of display panels and the pupil, wherein the third driving unit includes an outer pipe having a hollow inside and a through hole formed through an outer circumferential surface, an inner pipe movably inserted into the outer pipe and a motor controlling a moving direction and/or amount of the inner pipe.

In an embodiment, the outer pipe and the inner pipe are disposed in a longitudinal direction parallel to an optical axis of the multi-channel lens.

In an embodiment, the motor controls a moving direction and/or amount of the inner pipe according to whether the user wears glasses.

In an embodiment, the driving member includes a fourth driving unit capable of vertically moving the pair of display panels, wherein the fourth driving unit includes an outer pipe having a hollow inside and a through hole formed through an outer circumferential surface, an inner pipe movably inserted into the outer pipe and a motor for controlling a moving direction and/or a moving amount of an inner pipe based on the pupil position information.

In an embodiment, the outer pipe and the inner pipe of the fourth driving unit are disposed in a longitudinal direction perpendicular to an optical axis of the multi-channel lens.

In an embodiment, in a head-mounted display the entire image may clearly be checked by matching the center of the pupil and the center of the lens in a head-mounted display including multi-channel lenses. In addition, user satisfaction may be improved. Since the pupil is located at the center of the eye box, the border line may not be visible.

However, the effects of the disclosure are not limited to the aforementioned effects, and various other effects are included in the present specification.

### BRIEF DESCRIPTION OF THE DRAWINGS

FIG. 1 is a front view illustrating a head-mounted display, according to an embodiment.

FIG. 2 is a side view illustrating a head-mounted display, according to an embodiment.

FIG. 3 is a partial perspective view of a head-mounted display, according to an embodiment.

FIG. 4 is a side perspective view illustrating the multi-channel lens shown in FIG. 1, FIG. 2 and FIG. 3, according to an embodiment.

FIG. 5 is a side perspective view illustrating the multi-channel lens shown in FIG. 1, FIG. 2 and FIG. 3, according to an embodiment.

FIG. 6A is a graphical diagram for explaining a case where the center of the user's pupil and the center of the lens coincide, according to an embodiment.

FIG. 6B is a graphical diagram illustrating a VR image recognized by the user when the center of the user's pupil coincides with the center of the lens as shown in FIG. 6A, according to an embodiment.

FIG. 7A is a graphical diagram for explaining a case where the center of the user's pupil and the center of the lens do not match, according to an embodiment.

FIG. 7B is a graphical diagram illustrating a VR image recognized by the user when the center of the user's pupil and the center of the lens do not match as shown in FIG. 7A, according to an embodiment.

FIG. 8A is a graphical diagram for explaining another case in which the center of the user's pupil and the center of the lens do not match, according to an embodiment.

FIG. 8B is a graphical diagram illustrating a VR image recognized by the user when the center of the user's pupil and the center of the lens do not match as shown in FIG. 8A, according to an embodiment.

FIG. 9 is an exploded perspective view of a first driving unit of a driving member, according to an embodiment.

FIG. 10 is a side perspective view of the first driving unit of FIG. 9 for explaining the operation of the first driving unit, according to an embodiment.

FIG. 11 is a front view of a user wearing the head mounted display of FIG. 1 for explaining the operation of the first driving unit, according to an embodiment.

FIG. 12A is a side view of a user wearing the HMD of FIG. 1 for explaining a second driving unit of a driving member according, to an embodiment.

FIG. 12B is a side view of a user wearing the HMD of FIG. 1 for explaining a second driving unit of a driving member, according to an embodiment.

FIG. 12C is a side view of a user wearing the HMD of FIG. 1 for explaining a second driving unit of a driving member, according to an embodiment.

FIG. 13 is a graphical diagram for explaining an optical axis according to the operation of the second driving unit of FIG. 12, according to an embodiment.

FIG. 14 is a partial side view of an HMD for explaining a third driving unit of a driving member, according to an embodiment.

FIG. 15 is a side view of a user wearing an HMD for explaining the operation of the third driving unit of FIG. 14, according to an embodiment.

FIG. 16 is a side view of a user wearing an HMD for explaining the operation of the third driving unit of FIG. 14, according to an embodiment.

FIG. 17 is a graphical diagram for explaining the movement of the lens according to the operation of the third driving unit, according to an embodiment.

FIG. 18 is a partial perspective view for explaining a fourth driving unit of a driving member according to an embodiment.

FIG. 19 is a side view of a user wearing the HMD for explaining the operation of the fourth driving unit of FIG. 18, according to an embodiment.

FIG. 20 is a schematic block diagram illustrating a schematic configuration of a head-mounted display, according to an embodiment.

### DETAILED DESCRIPTION

The embodiments will now be described more fully hereinafter with reference to the accompanying drawings. The embodiments may however, be provided in different forms and should not be construed as limiting. The same reference numbers indicate the same components throughout the disclosure. In the accompanying figures, the thickness of layers and regions may be exaggerated for clarity.

Some of the parts which are not associated with the description may not be provided in order to describe embodiments.

It will also be understood that when a layer is referred to as being “on” another layer or substrate, it can be directly on the other layer or substrate, or intervening layers may also be present. In contrast, when an element is referred to as being “directly on” another element, there may be no intervening elements present.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

The spatially relative terms “below,” “beneath,” “lower,” “above,” “upper,” or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

When an element is referred to as being “connected” or “coupled” to another element, the element may be “directly connected” or “directly coupled” to another element, or “electrically connected” or “electrically coupled” to another element with one or more intervening elements interposed therebetween. It will be further understood that when the terms “comprises,” “comprising,” “has,” “have,” “having,” “includes” and/or “including” are used, they may specify the presence of stated features, integers, steps, operations, elements and/or components, but do not preclude the presence or addition of other features, integers, steps, operations, elements, components, and/or any combination thereof.

It will be understood that, although the terms “first,” “second,” “third,” or the like may be used herein to describe various elements, these elements should not be limited by these terms. These terms are used to distinguish one element from another element or for the convenience of description and explanation thereof. For example, when “a first element” is discussed in the description, it may be termed “a second element” or “a third element,” and “a second element” and “a third element” may be termed in a similar manner without departing from the teachings herein.

The terms “about” or “approximately” as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, “about” may mean within one or more standard deviations, or within ±30%, 20%, 10%, 5% of the stated value.

The term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.” The phrase “at least one of” is intended to include the meaning of “at least one selected from the group of” for the purpose of its meaning and interpretation. For example, “at least one of A and B” may be understood to mean “A, B, or A and B.”

Unless otherwise defined or implied, all terms used herein (including technical and scientific terms) have the same meaning as commonly understood by those skilled in the art to which this disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

Hereinafter, embodiments of the disclosure will be described in detail with reference to the accompanying drawings. Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. A region illustrated or described as flat may typically, have rough and/or nonlinear features, for example. Moreover, sharp angles that are illustrated may be rounded. Thus, the regions illustrated in the drawing figures are schematic in nature and their shapes are not intended to illustrate the precise shape of a region and are not intended to limit the scope of the claims.

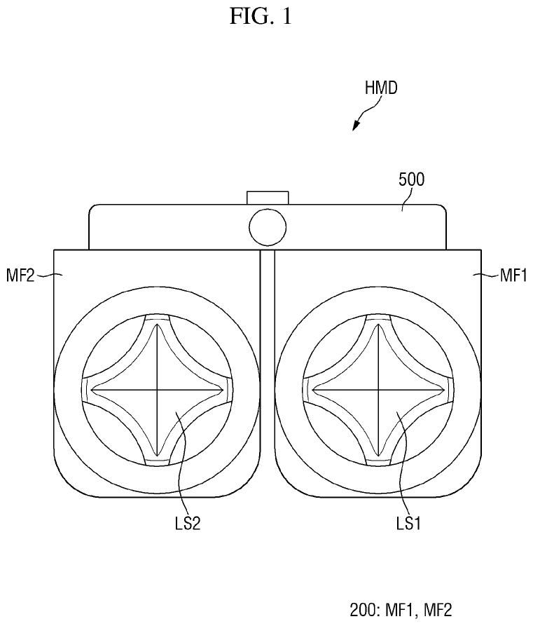

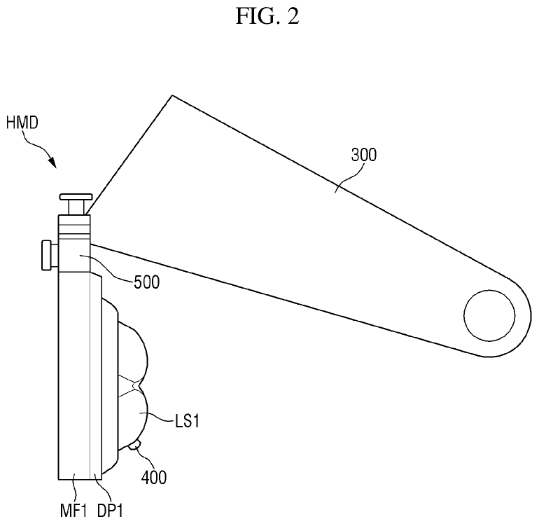

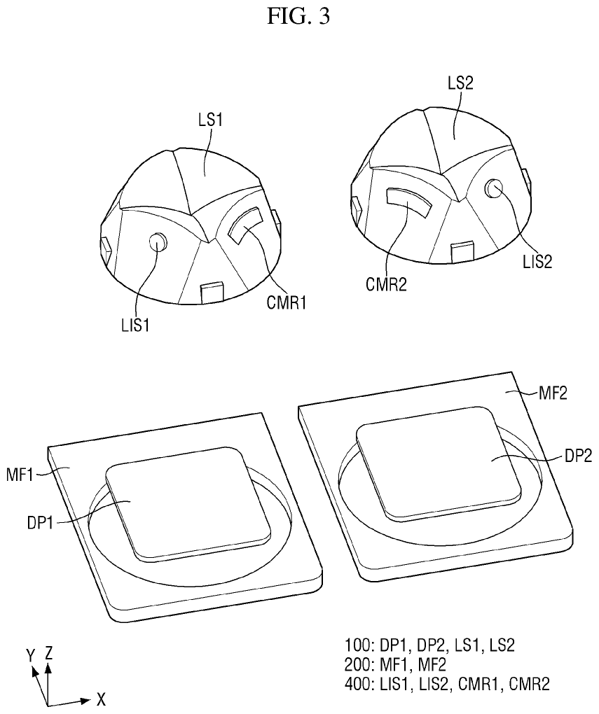

FIG. 1 is a front view of a head-mounted display according to an embodiment. FIG. 2 is a side view of a head-mounted display according to an embodiment. FIG. 3 is a partial perspective view of a head-mounted display according to an embodiment.

Referring to FIGS. 1 to 3, a head-mounted display HMD according to an embodiment is a wearable device that may be easily attached to and/or detached from a user's face and/or head and may further include a display unit 100, a frame 200, a hair band 300, an eye tracking member 400, and/or a driving member 500.

In an embodiment and referring to FIGS. 1 to 3, the display unit 100 includes display panels DP1 and DP2 displaying images and multi-channel lenses LS1 and LS2 forming an optical path so that the image display light of the display panels DP1 and DP2 is visible to a user.

In an embodiment, the display panels DP1 and DP2 may include a first display panel DP1 and a second display panel DP2 and may display images and/or videos. The display panels DP1 and DP2 may emit light for providing images and/or videos. As will be described later, the first and second multi-channel lenses LS1 and LS2 may be disposed on the front surface of the display panels DP1 and DP2, that is, on the light output path.

In an embodiment, the display panels DP1 and DP2 may be provided in a fixed state to the frame 200 or may be fixed to the frame 200 through a separate fixing member. The display panels DP1 and DP2 may be opaque, transparent, and/or translucent according to the design of the display unit 100, for example, the type of the display unit 100.

In an embodiment, the display panels DP1 and DP2 may include the first display panel DP1 and the second display panel DP2, respectively, corresponding to the left and right eyes, respectively. Each of the first display panel DP1 and the second display panel DP2 may be an organic light emitting display panel using an organic light emitting diode, a micro light emitting diode display panel using a micro light emitting diode, a quantum dot light emitting display panel using a quantum dot light emitting diode, and/or an inorganic light emitting display panel using an inorganic light emitting diode. An image output by the first display panel DP1 may be a left eye image. An image output by the second display panel DP2 may be a right eye image.

In an embodiment, the multi-channel lenses LS1 and LS2 may include a first multi-channel lens LS1 and a second multi-channel lens LS2 corresponding to the left and right eyes, respectively.

In an embodiment, the first multi-channel lens LS1 is disposed on the front surface of the first display panel DP1 to form a path of light emitted from the first display panel DP1 so that the image display light may be visible to the user's eyes in the front direction.

Similarly, the second multi-channel lens LS2 is disposed on the front surface of the second display panel DP2 to form a path of light emitted from the second display panel DP2 so that the image display light may be visible to the user's eyes in the front direction.

In an embodiment, each of the first and second multi-channel lenses LS1 and LS2, respectively, may provide a plurality of channels (or paths) through which image display light emitted from the first and second display panels DP1 and DP2, respectively, passes. The plurality of channels may pass image display light emitted from the first display panel DP1 and second display panel DP2 through different paths and provide the light to the user.

In an embodiment, the first and second multi-channel lenses LS1 and LS2, respectively, may refract and reflect the image display light emitted from the first display panel DP1 and/or the second display panel DP2 at least once to form a path to the user's eyes.

In an embodiment, the frame 200 may include a pair of frames MF1 and MF2 corresponding to the left and right eyes, respectively. A first frame MF1 and a second frame MF2, which are a pair of frames MF1 and MF2, are disposed on the first display panel DP1 and the second display panel DP2 toward the rear surface of the first display panel DP1 and the rear surface of the second display panel DP2 to cover the first display panel DP1 and the second display panel DP2, respectively, and may protect the first display panel DP1 and the second display panel DP2. The first frame MF1 and the second frame MF2 may be connected to the hair band 300 through a driving member 500 which will be described later.

In an embodiment, although the hair band 300 is attached to the user's body and has a loop shape that is generally horizontal when worn, it is not limited thereto. In another embodiment, an overhead loop that is generally vertical when worn may be further provided.

In an embodiment, the hair band 300 may be made of a semi-rigid member. The semi-rigid member may be and/or may include a resilient semi-rigid material, such as plastic and/or metal including, for example, aluminum and/or a shape memory alloy such as a copper-aluminum-nickel alloy. A buffer material may partially or entirely extend around the inside (touching the head) portion of the hair band 300 to provide comfortable contact with the user's head. The buffer material may be and/or may include, for example, polyurethane, polyurethane foam, rubber, plastic and/or other polymers. The buffer material may alternatively be and/or may include fibers and/or fabrics. Other materials may be considered for both the semi-rigid member and the buffer material.

In an embodiment, the eye tracking member 400 is a member capable of eye tracking, and may include light sources LIS1 and LIS2, a first camera sensor CMR1, and a second camera sensor CMR2.

In an embodiment, the first light source LIS1 and the first camera sensor CMR1 may be disposed outside the first multi-channel lens LS1, and the second light source LIS2 and the second camera sensor CMR2 may be disposed outside the second multi-channel lens LS2 and disposed to be directed toward the user's eyes. The first light source LIS1 and the second light source LIS2 emit the light having the first wavelength to one object, that is, the user's eyeball. The first camera sensor CMR1 and the second camera sensor CMR2 detect various types of cameras and/or light and may be capable of detecting light of a first wavelength reflected from the object and/or may include a photoelectric conversion element such as an image sensor that generates a charge. In another embodiment, the first light source LIS1 and the first camera sensor CMR1 may be integrally formed.

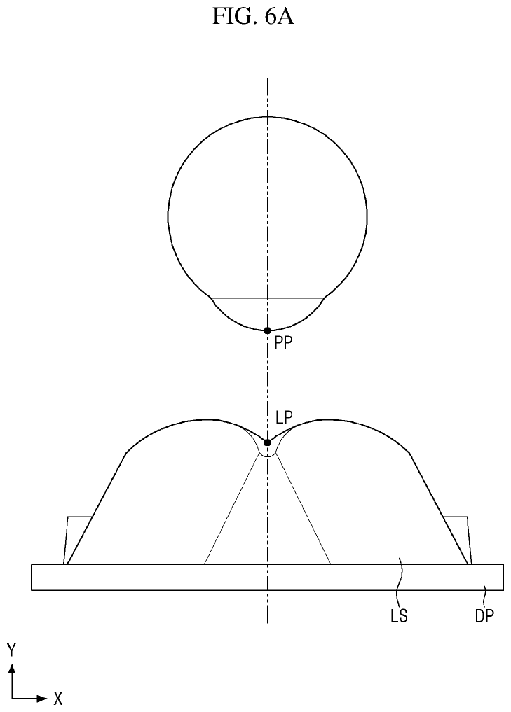

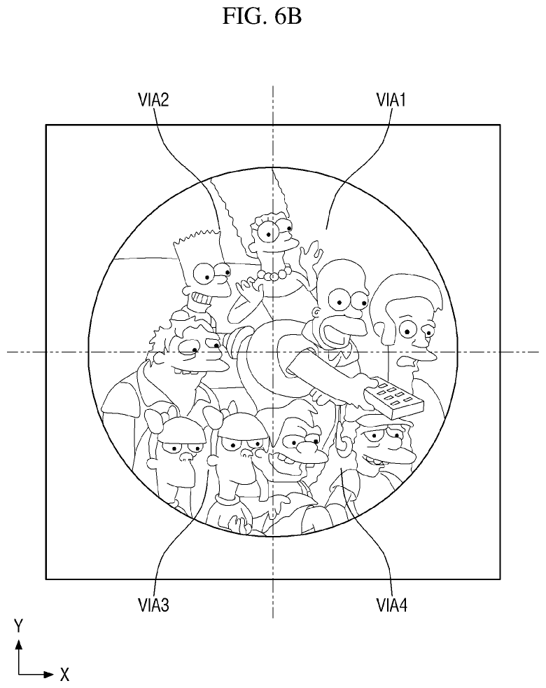

In an embodiment, the eye tracking member 400 may process eye images acquired through the first camera sensor CMR1 and the second camera sensor CMR2 with an eye tracking algorithm to specify the pupil position. The eye tracking algorithm may be a pretrained eye tracking model based on artificial intelligence, and/or the eye tracking model can be created using CNN, RNN, LSTM RNN, ResNet, MobileNet, Weighted Random Forest Classifier (WRFR), Cascade Regression Forest, etc. For example, the eye tracking algorithm may detect the outline of the user's pupil PP (See FIG. 6A) from images obtained through the first camera sensor CMR1 and the second camera sensor CMR2.

In an embodiment, the driving member 500 is connected to the first frame MF1 and the second frame MF2, so that the first frame MF1 and the second frame MF2 may be tilted and/or translated vertically and/or horizontally. The driving member 500 may adjust tilting and/or moving up, down, left, and/or right according to the result of the eye tracking. According to the movement of the driving member 500, alignment of the center of the multi-channel lenses LS1 and LS2 and the center of the eyeball, optical axis adjustment of multi-channel lenses LS1 and LS2, angle adjustment of multi-channel lenses LS1 and LS2, and/or the distance between the multi-channel lenses LS1 and LS2 and the eyes may be adjusted. Hereinafter, the multi-channel lenses LS1 and LS2 may be referred to as lenses for convenience of explanation. For example, the center of the multi-channel lenses LS1 and LS2 may be referred to as the center of the lens, the optical axis of the multi-channel lens LS1 and LS2 may be referred to as the optical axis of the lens, and the angles of the multi-channel lenses LS1 and LS2 may be referred to as lens angles. Regarding the alignment of the center of the lens and the center of the eyeball, the adjusting the optical axis of the lens, the lens angle adjustment, and the adjustment of the gap between the lens and the eye will be described later with reference to FIGS. 6A to 15.

In an embodiment, although not shown, the head-mounted display HMD may further include a control unit for controlling the overall operation of the head-mounted display HMD including the display unit 100, the eye tracking member 400, and the driving member 500. For example, the control unit may control an image display operation of the display panels DP1 and DP2 and/or an audio device. Also, the control unit may control driving of the driving member 500 based on the eye tracking result generated by the eye tracking member 400. For example, the control unit may align the center of the lens with the center of the eyeball, adjust the optical axis of the lens, adjust the angle of the lens, and/or adjust the distance between the lens and the eye by controlling the drive member 500 according to the wearer's pupil position without using hands.

In an embodiment, the control unit may be implemented as a dedicated processor including a processor and/or a general-purpose processor including a central processing unit and/or an application processor but is not limited thereto.

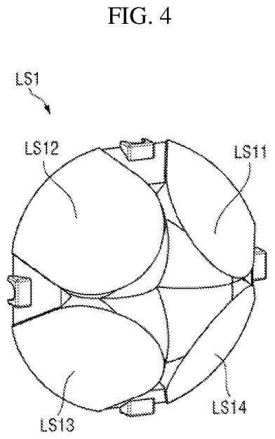

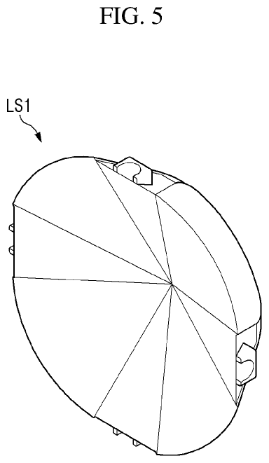

FIG. 4 is a side perspective view of the multi-channel lens shown in FIGS. 1 to 3, according to an embodiment. FIG. 5 is another side perspective view of the multi-channel lens shown in FIGS. 1 to 3, according to an embodiment.

In an embodiment and referring to FIGS. 3 to 5, the first and second multi-channel lenses LS1 and LS2, respectively, are disposed in front of the first display panel DP1 and the second display panel DP2 and may be positioned at points corresponding to the user's eyes respectively.

In an embodiment, the first and second multi-channel lenses LS1 and LS2, respectively, corresponding to the user's eyes are disposed symmetrically with each other, and the first and second multi-channel lenses LS1 and LS2, respectively, may have substantially the same or similar structures but is not limited thereto.

In an embodiment, each of the first and second multi-channel lenses LS1 and LS2, respectively, may include a plurality of sub lenses.

FIGS. 4 and 5 illustrate one side and the other side, respectively, of the first multi-channel lens LS1, according to an embodiment.

FIG. 4 is a perspective view of one side of the first multi-channel lens LS1 facing the user's eye, according to an embodiment.

In an embodiment and referring to FIG. 4, the cross section of the first multi-channel lens LS1 may be formed in an approximate hemispherical shape. At this time, one side of the first multi-channel lens LS1 facing the user's eye is formed in a convex shape, and the other side of the first multi-channel lens LS1 facing the first display panel DP1 or the first frame MF1 may be formed in a concave shape as shown in FIG. 5 to be described later.

In an embodiment, since the second multi-channel lens LS2 is substantially the same as or similar to the first multi-channel lens LS1, the first multi-channel lens LS1 will be mainly described below.

In an embodiment, the first multi-channel lens LS1 illustrated in FIG. 4 may 4 may have a substantially circular shape on a plane. The first multi-channel lens LS1 may include a first sub-lens LS11, a second sub-lens LS12, a third sub-lens LS13, and a fourth sub-lens LS14. The first sub-lens LS11, the second sub-lens LS12, the third sub-lens LS13, and the fourth sub-lens LS14 may be arranged in a clover shape, for example, to surround the center of the circle on a plane. For example, as shown in FIG. 4, each of the first sub-lens LS11, the second sub-lens LS12, the third sub-lens LS13, and the fourth sub-lens LS14 may be disposed at upper right, upper left, lower left, and lower right with respect to the center of the first multi-channel lens LS1, respectively. The first sub-lens LS11, the second sub-lens LS12, the third sub-lens LS13, and the fourth sub-lens LS14 may be integrally connected to each other and/or separated from each other.

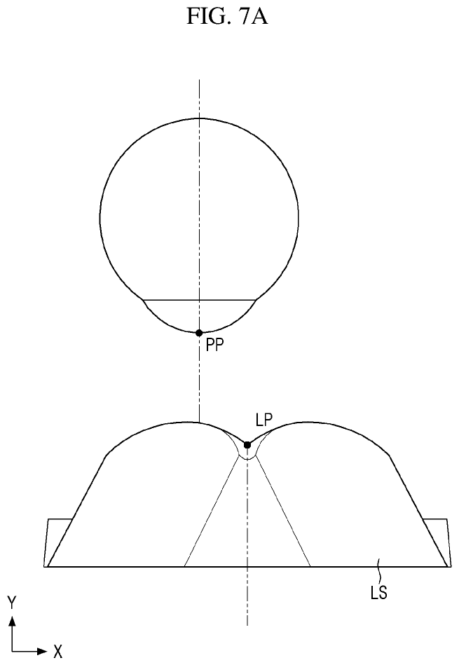

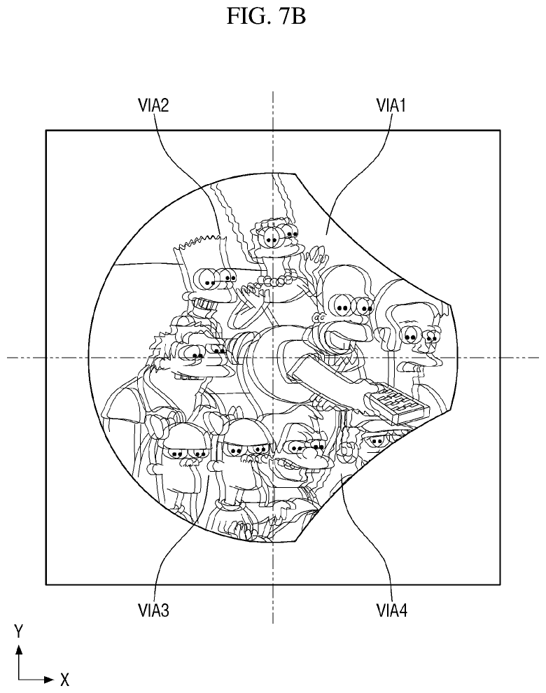

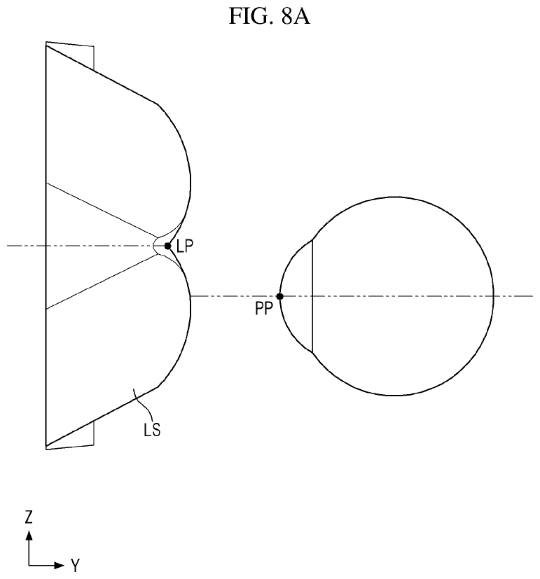

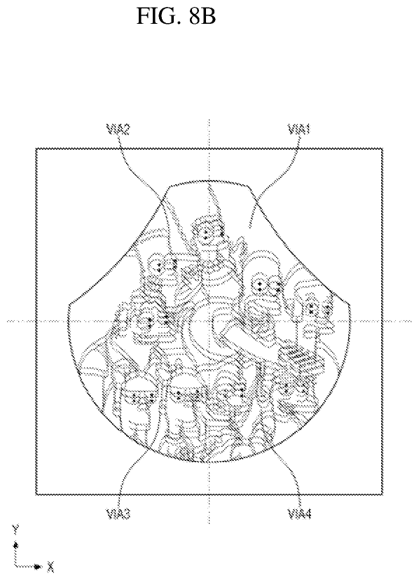

FIG. 6A is a graphical diagram for explaining a case where the center of the user's pupil and the center of the lens coincide, according to an embodiment, and FIG. 6B is a graphical diagram illustrating a VR image recognized by the user when the center of the user's pupil coincides with the center of the lens, as shown in FIG. 6A, according to an embodiment. FIG. 7A is a graphical diagram for explaining a case where the center of the user's pupil and the center of the lens do not match, according to an embodiment, and FIG. 7B is a graphical diagram illustrating a VR image recognized by the user when the center of the user's pupil and the center of the lens do not match, as shown in FIG. 7A, according to an embodiment. FIG. 8A is a graphical diagram for explaining another case in which the center of the user's pupil and the center of the lens do not match, according to an embodiment, and FIG. 8B is a graphical diagram illustrating a VR image recognized by the user when the center of the user's pupil and the center of the lens do not match, as shown in FIG. 8A, according to an embodiment.

As described above, in an embodiment, configurations and operations corresponding to one eye of the user (e.g., left eye) are substantially the same as or similar to configurations and operations corresponding to the other eye (e.g., right eye) of the user in the display unit (100 in FIG. 3). Hereinafter, the configuration (first lens, LS1) corresponding to one eye of the user will be mainly described.

In an embodiment and as described above, the position of the user's pupil PP may be calculated by the eye tracking member (400 in FIG. 3). The driving member (500 in FIG. 2) may perform the alignment of center of the lens and the center of the eyeball, the adjustment of the optical axis of the lens, the adjustment of the lens angle, and/or the adjustment of the distance between the lens and the eye based on the calculated position of the user's pupil PP.

Referring to FIG. 6A, a virtual plane for setting coordinates corresponding to the position of the user's pupil PP may be defined according to an embodiment. For example, as described above, the outline of the user's pupil PP is detected by the eye tracking member 400, and the control unit may set the center point of the shape defined by the outline as the coordinates of the pupil PP.

In an embodiment, the driving member 500 may overlap the center of the multi-channel lens LS in the thickness direction based on the origin of the virtual plane.

In an embodiment, the display unit 100 may output a foveated rendered VR image to the display panel DP. The VR image may refer to an image and/or video recognized by a user through the multi-channel lens LS. In the foveated rendering, only the area gazed by the user's gaze is displayed with maximum quality, and other areas are displayed with low quality. Therefore, it may refer to an image processing method that minimizes the graphic computational load while implementing a high-definition VR experience with a high degree of immersion.

In an embodiment and referring to FIG. 6B, the VR image may include a first divided viewing area VIA1, a second divided viewing area VIA2, a third divided viewing area VIA3, and a fourth divided viewing area VIA4 in a counterclockwise direction.

In an embodiment, a central area of a VR image may have a relatively higher pixel density than surrounding areas. In this case, the pixel density may increase incrementally from the edge of the VR image to the center of the VR image. Accordingly, the central area of the VR image may be displayed with a higher quality than the surrounding area.

In an embodiment, when the lens center LP of the lens and the center of the eyeball are aligned based on the position of the pupil PP of the user as shown in FIG. 6A by the control of the driving member 500, all of the first divided viewing area VIA1, the second divided viewing area VIA2, the third divided viewing area VIA3, and the fourth divided viewing area VIA4 may be recognized without cutting off as shown in FIG. 6B.

Meanwhile, in an embodiment, when the position of the user's pupil PP and the center of the multi-channel lens LS do not match, the display image of a portion of the first divided viewing area VIA1, the second split viewing area VIA2, the third divided viewing area VIA3, and the fourth divided viewing area VIA4 may be cut off. Also, the entire image may be out of focus. For example, when the center of the user's pupil PP and the center of the multi-channel lens LS are displaced left and right in the first direction (X direction) as shown in FIG. 7A, a display image of a portion of the divided viewing area away from the position of the user's pupil PP may be cut off as shown in FIG. 7B. When the position of the user's pupil PP is moved from the center to the left side, the display image of a portion of the first divided viewing area VIA1 and the fourth divided viewing area VIA4 on the right side may be cut off. In addition, as shown in FIG. 8A, when the center of the user's pupil PP and the center of the multi-channel lens LS are vertically displaced in the third direction (Z direction), as shown in FIG. 8B, the display image of a portion of the divided viewing area distant from the position of the user's pupil PP may be cut off. When the position of the user's pupil PP moves downward from the center, a display image of any portion of the upper first divided viewing area VIA1 and/or the second divided viewing area VIA2 may be cut off.

As such, according to an embodiment, when the center of the pupil PP and the center of the lens LS are aligned in a head-mounted display including a multi-channel lens LS, the entire image may be seen clearly, and the luminance is optimized. In addition, since the pupil PP is located at the center of the eye box, the border line is not recognized. Here, the eye box means a range in which the pupil may be positioned to observe an image due to the characteristics of a near-eye display.

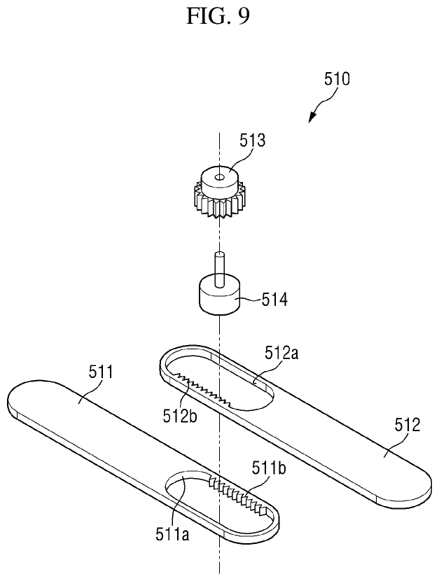

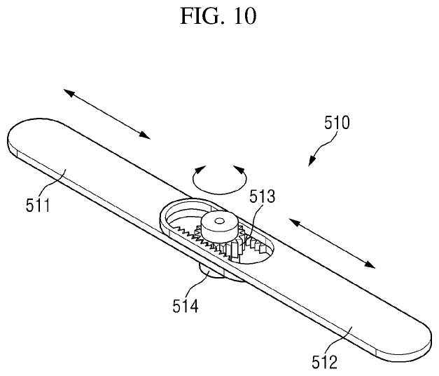

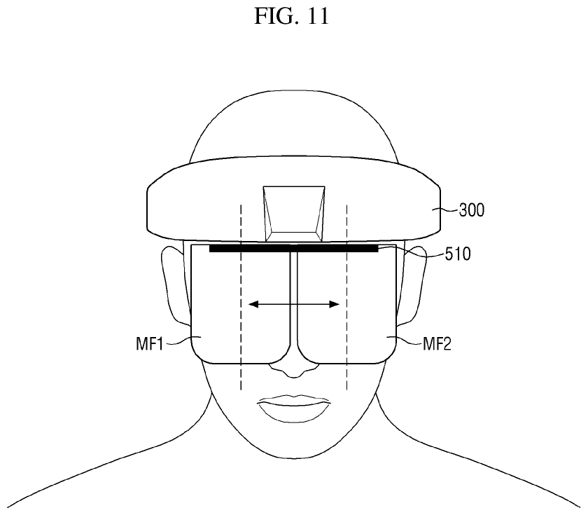

FIG. 9 is an exploded perspective view of a first driving unit of a driving member, according to an embodiment. FIGS. 10 and 11 are views for explaining the operation of the first driving unit of FIG. 9, according to an embodiment.

In an embodiment and referring to FIG. 9, a first driving unit 510 may be disposed between the pair of frames MF1 and MF2 (See FIG. 3) and the hair band 300 (See FIG. 2). The first driving unit 510 may include a pair of plates 511 and 512, a rotating gear 513, and a driving motor 514.

In an embodiment, the pair of plates 511 and 512 are long in the longitudinal direction and have holes 511a and 512a, respectively, formed at one end. The holes 511a and 512a are long in the longitudinal direction and have tooth-shaped linear gears 511b and 512b, respectively, meshing with the rotating gear 513 on one side of the inner longitudinal direction.

In an embodiment, each of the holes 511a and 512a formed at one end of the pair of plates 511 and 512 is disposed to overlap at least a portion of each other, and the rotating gear 513 is disposed within the overlapped holes 511a and 512a.

In an embodiment, the linear gear 511b of the first plate 511 and the linear gear 512b of the second plate 512 face each other. Thus, when the first driving unit 510 drives the driving motor 514 to rotate the rotating gear 513, the pair of linear gears 511b and 512b meshed with the rotating gear 513 are linearly moved in opposite directions to each other. For example, when the rotating gear 513 is rotated clockwise, the pair of plates 511 and 512 move away from each other, and when the rotating gear 513 is rotated counterclockwise, the pair of plates 511 and 512 may come closer to each other.

In an embodiment, at this time, the pair of linear gears 511b and 512b may be connected to the first frame MF1 corresponding to the first multi-channel lens LS1 and the second frame MF2 corresponding to the second multi-channel lens LS2, respectively. Accordingly, the first multi-channel lens LS1 and the second multi-channel lens LS2 move simultaneously in the direction in which the linear gears 511b and 512b move and as a result, the center of the lens may match the center of the eyeball in the first direction (X direction).

In an embodiment, here, the first plate 511 has one end where the hole 511a is not formed and is fixedly coupled to the first frame MF1 with a screw or the like, and the second plate 512 has one end where the hole 512a is not formed and is fixedly coupled to the second frame MF2 with a screw or the like. Each of the holes 511a and 512a formed at one end of the pair of plates 511 and 512 may overlap at least a portion of each other and be positioned above the wearer's nose. The size of the holes 511a and 512a may have a width corresponding to the diameter of the rotating gear 513 and a length within a range in which the plates 511 and 512 move according to the adjustment of the distance between the pupils so that the rotating gear 513 may be inserted and coupled. The shapes of the first plate 511 and the second plate 512 may be basically the same, but the positions or directions of the holes 511a and 512a or the linear gears 511b and 512b formed inside the holes 511a and 512a, may be different from each other as needed.

In an embodiment, the first driving unit 510 according to an embodiment of the present disclosure may adjust the distance between the center of the lens and the center of the pupil PP by simultaneously moving the first frame MF1 and the second frame MF2.

In an embodiment, the first driving unit 510, as described above, controls the positions of the first frame MF1 and the second frame MF2 based on the x position of the coordinates corresponding to the position of the user's pupil PP.

To this end, in an embodiment, mapping data including position values of the first frame MF1 and the second frame MF2 mapped to the obtained coordinates of the pupil may be stored in advance as described above. In this case, the control unit may transmit a first signal for controlling the rotating gear 513 of the first driving unit 510 to the first driving unit 510 based on pre-stored mapping data. The first driving unit 510 may control the distance between the first frame MF1 and the second frame MF2 by driving a motor 514 based on the first signal. For example, the first driving unit 510 rotates the rotating gear 513 in a counterclockwise direction to control and cause the distance between the first frame MF1 and the second frame MF2 to be narrowed, the rotating gear 513 may be rotated in a clockwise direction to widen the distance between the first frame MF1 and the second frame MF2.

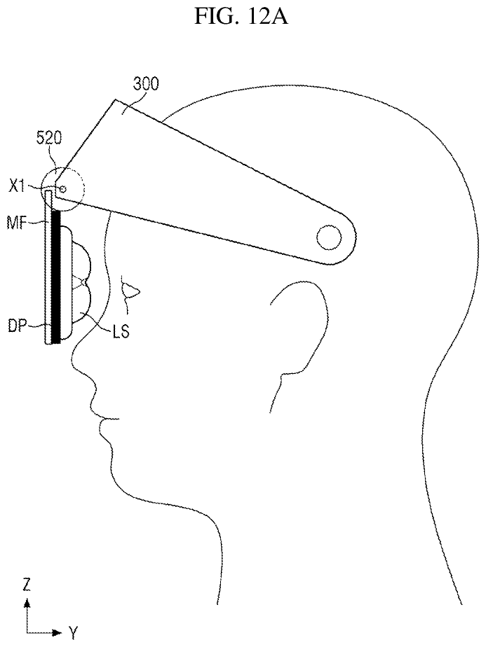

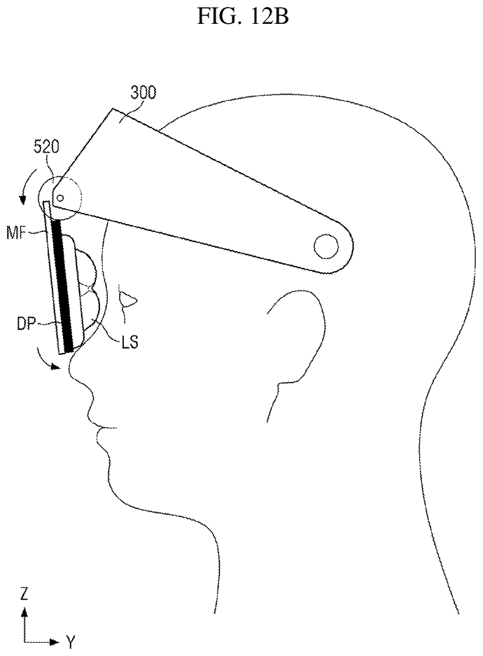

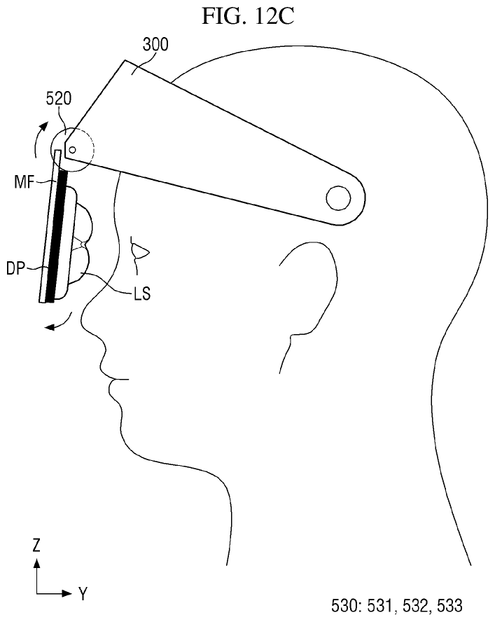

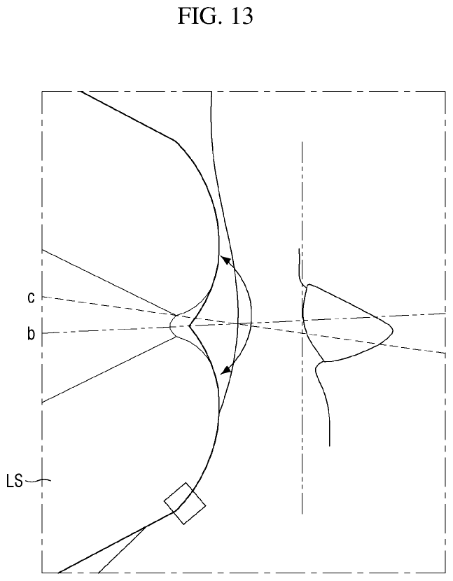

FIGS. 12A to 12C are views for explaining a second driving unit of a driving member according to an embodiment. FIG. 13 is a diagram for explaining an optical axis according to the operation of the second driving unit of FIG. 12A, according to an embodiment.

In an embodiment and referring to FIGS. 12A to 12C, the second driving unit 520 is a driving member capable of linear driving for adjusting the wide-angle tilt output from the multi-channel lens LS. The second driving unit 520 may adjust the tilting angle of the multi-channel lens LS around the central axis. Therefore, the second driving unit 520 may tilt the wide angle of the multi-channel lens LS by moving the multi-channel lens LS clockwise and/or counterclockwise. Here, the direction of the central axis may coincide with the arrangement direction of the pair of display panels DP. In an embodiment, the second driving unit 520 may be formed in a cylindrical shape, may be hinge-coupled with the hair band 300, and may perform a tilting motion around the hinge axis X1. The second driving unit 520 may be coupled to the first driving unit 510. The second driving unit 520 and the first driving unit 510 are coupled so as not to interfere with each other's driving. For example, the second driving unit 520 may be coupled to one end of the first plate 511 of the first driving unit 510 where the hole 511a is not formed and the other end of the second plate 512 where the hole 512a is not formed, respectively. The pair of second driving units 520 should be formed symmetrically and tilted at the same angle. The second driving unit 520 may control tilting angles of the first frame MF1 and the second frame MF2 through the first driving unit 510. The optical axes of the first multi-channel lens LS1 and the second multi-channel lens LS2 respectively disposed on the first frame MF1 and the second frame MF2 may be controlled by tilting the first frame MF1 and the second frame MF2. To this end, the second driving unit 520 may have a motor.

In an embodiment, the control unit may control the tilting angle of the second driving unit 520 so that the optical axes of the first multi-channel lens LS1 and the second multi-channel lens LS2 coincide based on pupil coordinates.

To this end, as described above in an embodiment, mapping data including a tilting angle mapped according to the obtained pupil coordinates may be stored in advance. In this case, the control unit may transmit a second signal for controlling the tilting angle of the second driving unit 520 to the second driving unit 520 based on previously stored mapping data. The second driving unit 520 may control the tilting angle by driving a motor based on the second signal.

FIG. 12A illustrates an embodiment where the second driving unit 520 is located above the frame MF but is not limited thereto. In an embodiment, in the case of including a separate connecting member connecting the hair band 300 and the frame MF, it may be disposed between the separate connecting member and the frame MF.

FIG. 12B is an example in which the second driving unit 520 is moved counterclockwise. As shown in FIG. 12B, in an embodiment, when the second driving unit 520 is moved counterclockwise, the multi-channel lens LS may also be tilted counterclockwise. As shown in FIG. 13, the optical axis of the multi-channel lens LS is also tilted counterclockwise, according to an embodiment, that is, the optical axis is inclined from c to b.

According to an embodiment, FIG. 12C is an example in which the second driving unit 520 is moved clockwise. As shown in FIG. 12C, when the second driving unit 520 is moved clockwise, the multi-channel lens LS may also be tilted clockwise. As shown in FIG. 13, the optical axis of the multi-channel lens LS is also tilted clockwise, that is, the optical axis is inclined from b to c.

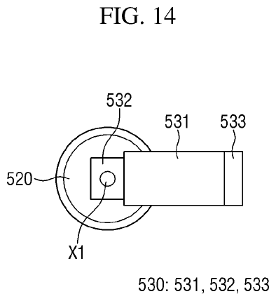

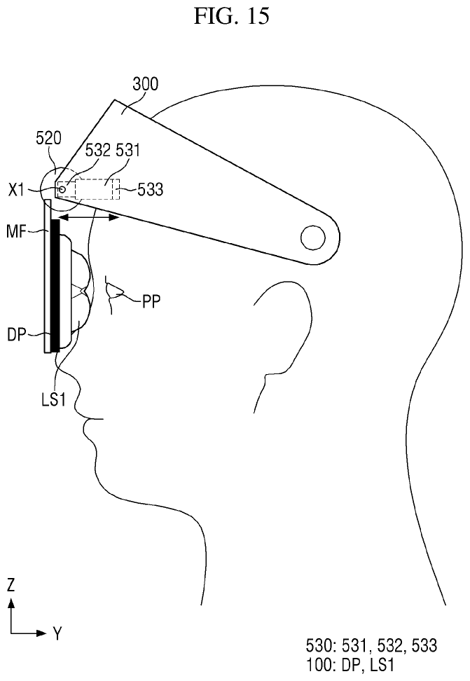

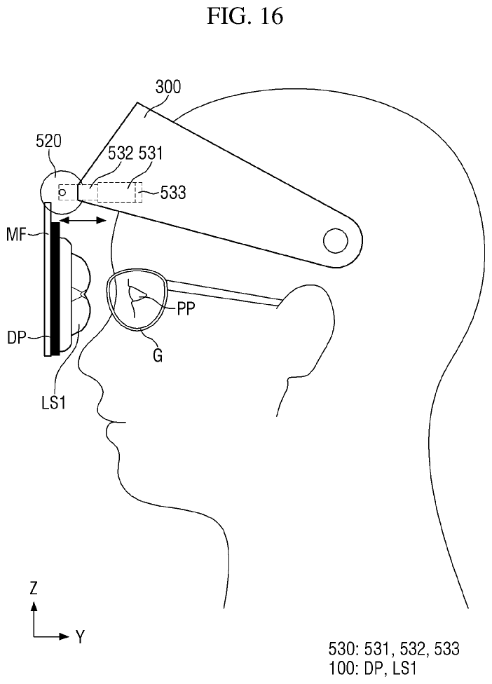

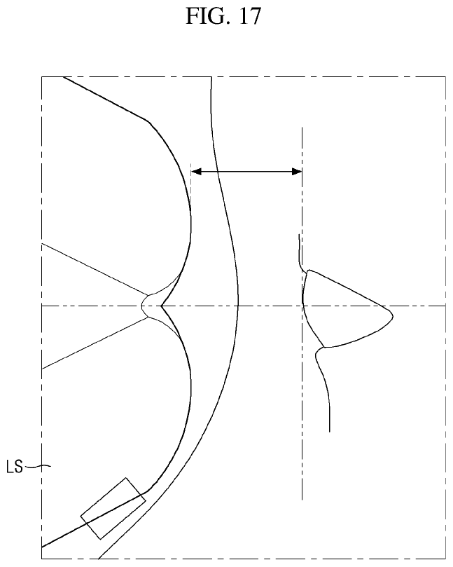

FIG. 14 is a view for explaining a third driving unit of a driving member according to an embodiment. In an embodiment, FIGS. 15 and 16 are diagrams for explaining the operation of the third driving unit of FIG. 14 and FIG. 17 is a diagram for explaining the movement of the lens according to the operation of the third driving unit.

In an embodiment and referring to FIGS. 14 to 16, a third driving unit 530 adjusts eye relief of the display unit 100. The eye relief is a range in which an image size may be viewed without loss and/or may be defined as a distance from the multi-channel lens LS, which is the final surface of the optical system, to the eye.

In an embodiment, the third unit 530 adjusts the distance between the multi-channel lens LS1 and the pupil PP. The third driving unit 530 may have one end connected to the hair band 300 and one end connected to the frame MF. One end of the third driving unit 530 may be connected to the frame MF through the second driving unit 520.

In an embodiment, the third driving unit 530 may include an outer pipe 531, an inner pipe 532, and a motor 533.

In an embodiment, the outer pipe 531 has a hollow inside and a through hole formed through the outer circumferential surface. The outer pipe 531 is disposed in a longitudinal direction parallel to the optical axis of the lens.

In an embodiment, the inner pipe 532 has a hollow inside and is movably inserted into the outer pipe 531 by a motor 533. The motor 533 may adjust the movement direction and/or movement amount of the inner pipe 532. The inner pipe 532 is disposed in a longitudinal direction parallel to the optical axis of the lens.

In an embodiment, as the inner pipe 532 is moved inside the outer pipe 531 by the motor 533, the entire length of the third driving unit 530 may be shortened. In this case, the distance between the frame MF and the pupil PP is shortened by the third driving unit 530.

In an embodiment, as the inner pipe 532 is moved to the outside of the outer pipe 531 by the motor 533, the entire length of the third driving unit 530 may be increased. In this case, the distance between the frame MF and the pupil PP is increased by the third driving unit 530.

In an embodiment, it is possible to determine whether the user wears glasses through analysis of an image captured by the first camera sensor CMR1 of the eye tracking member (400 in FIG. 3). The eye tracking member (400 in FIG. 3) may transmit a result of determining whether the user wears glasses to the third driving unit 530. As shown in FIG. 16, the third driving unit 530 may adjust the eye relief longer when the user wears glasses G or the like.

In another embodiment, whether the user wears glasses may be input in advance and stored.

In an embodiment, the third driving unit 530 may adjust the length of the eye relief based on stored information on whether the user wears glasses.

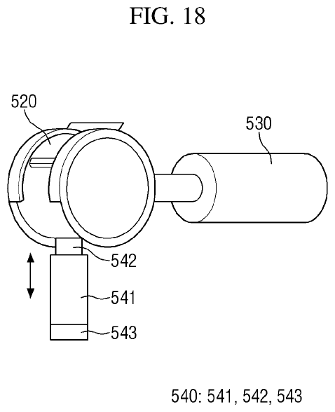

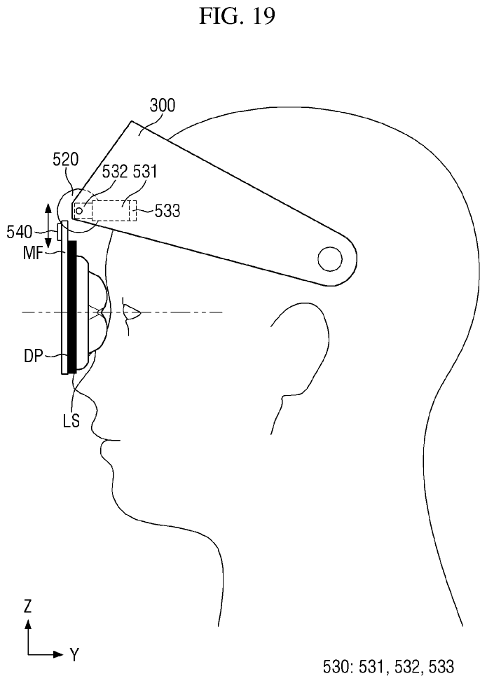

FIG. 18 is a view for explaining a fourth driving unit of a driving member according to an embodiment. FIG. 19 is a diagram for explaining the operation of the fourth driving unit of FIG. 18 according to an embodiment.

In an embodiment, t fourth driving unit 540 is a driving unit that enables the frame MF to move up and down in the third direction (Z direction). The fourth drive unit 540 may have one end connected to the frame MF and the other end connected to the lower end of the first drive unit 510 in FIG. 11. The fourth driving unit 540 may include an outer pipe 541, an inner pipe 542, and a motor 543.

In an embodiment, the outer pipe 541 has a hollow inside and a through hole formed through the outer circumferential surface. The outer pipe 541 may be disposed in a longitudinal direction perpendicular to the optical axis of the lens.

In an embodiment, the inner pipe 542 has a hollow inside and is movably inserted into the outer pipe 541 by the motor 543. The inner pipe 542 may be disposed in a longitudinal direction perpendicular to the optical axis of the lens.

In an embodiment, the inner pipe 542 is moved inside and/or outside the outer pipe 541 by the motor 543 so that the entire length of the fourth driving unit 540 may be adjusted to be shorter and/or longer. In this case, the position of the frame MF in the third direction (Z direction) may be adjusted by the fourth driving unit 540.

In an embodiment, as the inner pipe 542 is moved to the outside of the outer pipe 541 by the motor 543, the entire length of the fourth driving unit 540 may be increased. In this case, the frame MF is moved downward by the fourth driving unit 540. Thereby, the optical axis of lens LS moves downward.

In an embodiment, as the inner pipe 542 is moved inside the outer pipe 541 by the motor 543, the entire length of the fourth driving unit 540 may be shortened. In this case, the frame MF moves upward by the fourth driving unit 540. Thereby, the optical axis of lens LS moves upward.

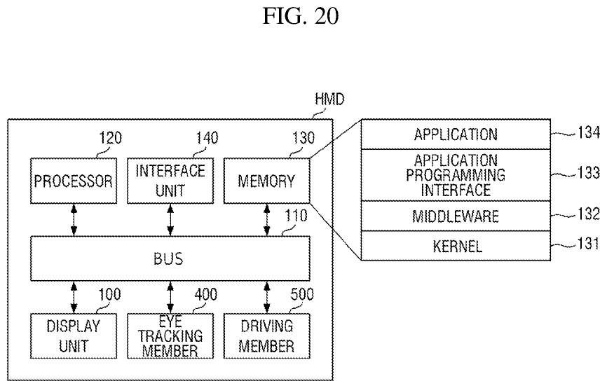

FIG. 20 is a block diagram illustrating a schematic configuration of a head-mounted display according to an embodiment.

In an embodiment and referring to FIG. 20, the head-mounted display HMD may include a bus 110, a processor 120, a memory 130, an interface unit 140, a display unit 100, an eye tracking member 400, and a driving member 500.

In an embodiment, the bus 110 may be a circuit that connects the aforementioned components to each other and transfers communication (e.g., a control message) between the aforementioned components.

In an embodiment, the processor 120 may receive, for example, a request, data, and/or signal from the above-mentioned other components (e.g., the memory 130, the display unit 100, the eye tracking member 400, the driving member 500, etc.) through the bus 110. Accordingly, it is possible to control the components by processing calculations and/or data.

In an embodiment, the processor 120 may process at least some of the information obtained from other components (e.g., the memory 130, the display unit 100, the eye tracking member 400, the driving member 500, etc.) and provide it to users in various ways.

For example, in an embodiment, the processor 120 may control driving of the driving member 500 based on pupil information (e.g., pupil coordinates) acquired from the eye tracking member 400.

In an embodiment, the processor 120 may store the initial pupil position acquired through the eye tracking member 400 in the memory 130. Then, the relative position of the measured pupil may be calculated. Thereafter, the pupil position obtained by the eye tracking member 400 may be compared with the initial pupil position, and the updated pupil position may be stored. However, when the eye tracking member 400 fails in eye tracking, the processor 120 may use the previously stored pupil position.

As described above, in an embodiment, the display panel DP may be moved vertically and/or horizontally and/or tilted by the driving of the driving member 500. For example, driving of the driving member 500 may be controlled so that the center of the lens and the center of the eyeball are aligned vertically and/or horizontally. Since the pupil is positioned at the center of the eye box, a borderline is not viewed and luminance may be optimized by matching the top, bottom, left and/or right of the center of the lens and the center of the eyeball.

In addition, driving of the driving member 500 may be controlled based on information on whether the user wears glasses. As described above, the display panel DP may be tilted and/or moved vertically and/or horizontally by driving the driving member 500. For example, driving of the driving member 500 may be controlled to adjust the eye relief and/or the angular tilt of the lens. Eye relief may be reduced when glasses are not worn. Also, the angle of view may be optimized by tilting the angle of the optical axis of the lens when wearing glasses.

In an embodiment, the memory 130 may store commands or data received from the processor 120 and/or the display unit 100 and/or generated by the processor 120 and/or the display unit 100. For example, the memory 130 may store an eye tracking model. The memory 130 may include, for example, programming modules such as a kernel 131, a middleware 132, an application programming interface (API) 133, and/or an application 134. Each of the programming modules described above may be composed of software, firmware, hardware, or a combination of at least two of these.

In an embodiment, the kernel 131 may control and/or manage the other programming modules, such as the middleware 132, the API 133, and/or the system resources used to execute operations and/or functions implemented in application 134 (e.g., the bus 110, the processor 120 or the memory 130, etc.). Also, the kernel 131 may provide an interface through which individual components of the display unit 100 may be accessed, controlled and/or managed in the middleware 132, the API 133, and/or the application 134.

In an embodiment, the middleware 132 may perform an intermediary role so that the API 133 and/or the application 134 communicates with the kernel 131 to exchange data. In addition, the middleware 132 may perform control (e.g., scheduling or load balancing) on job requests in relation to job requests received from the application 134, for example, by using a method such as assigning a priority for using system resources (e.g., a bus 110, a processor 120, or a memory 130, etc.) of the display unit 100 to at least one application among the applications 134.

In an embodiment, the API 133 is an interface for the application 134 to control functions provided by the kernel 131 and/or the middleware 132, and may include, for example, at least one interface and/or function (e.g., command) for file control, window control, image processing, and/or text control.

In an embodiment, the interface unit 140 means a user interface receives information through a user manipulation signal. For example, information corresponding to whether the user wears glasses may be input. The interface unit 140 may transfer input information to at least one of the memory 130 and the processor 120.

In an embodiment, the display unit 100 (and/or display module) may display various types of information (e.g., multimedia data or text data) to the user. For example, the display unit 100 may include a display panel (e.g., a liquid crystal display (LCD) panel or an organic light-emitting diode (OLED) panel, and/or a display driver IC (DDI)). The DDI may control pixels of a display panel to display colors. For example, the DDI may include a circuit that converts digital signals into RGB analog values and transmits them to the display panel.

However, the aspects of the disclosure are not restricted to the one set forth herein. The above and other aspects of the disclosure will become more apparent to one of daily skill in the art to which the disclosure pertains by referencing the claims, with functional equivalents thereof to be included therein. The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims. Moreover, the embodiments or parts of the embodiments may be combined in whole or in part without departing from the scope of the invention.

What is claimed is:

1. A head-mounted display comprising:
a pair of frames for being worn on a user's body and corresponding to the user's eyeballs which include a left eye and a right eye;
a display unit including a pair of display panels respectively mounted to the pair of frames, and a pair of multi-channel lenses disposed on a light output path of the pair of display panels; and
a driving member connected to the pair of frames to allow the pair of frames to tilt and/or move in an up, down, left, and right direction,
wherein the driving member aligns a center portion of each of the pair of multi-channel lenses in the up, down, left, and right directions with a center of a corresponding user's eyeball, adjusts an angle of the pair of multi-channel lenses, and adjusts a distance between the pair of multi-channel lenses and the corresponding user's eyeball.

2. The head-mounted display of claim 1, wherein the driving member comprises,
a first driving unit for adjusting a distance between the pair of display panels;
a second driving unit for tilting the pair of display panels about a central axis and adjusting a tilting angle of the pair of display panels;
a third driving unit for adjusting a distance between the pair of display panels and a pupil of the user's eyeballs; and
a fourth driving unit for vertically moving the pair of display panels.

3. The head-mounted display of claim 2, further comprising an eyeball tracking member including a camera disposed outside the pair of multi-channel lenses and disposed to be directed toward the user's eyeballs.

4. The head-mounted display of claim 3, wherein the eye tracking member obtains pupil position information from an image acquired by the camera based on a previously stored eye tracking algorithm.

5. The head-mounted display of claim 4, wherein the first driving unit comprises,
a pair of plates each fixed to the pair of frames and each having a long-shaped hole at one end directed in a longitudinal direction;
a rotating gear disposed within each of the long-shaped holes; and
a driving motor for rotating the rotation gear based on the pupil position information;
wherein the long-shaped holes are formed having a linear gear for meshing with the rotary gear on one side,
wherein the pair of plates is disposed such that each of the long-shaped holes overlaps at least a portion of each other.

6. The head-mounted display of claim 4, wherein the second driving unit comprises a motor controlling a tilting direction and a degree of tilting of the pair of display panels based on the pupil position information.

7. The head-mounted display of claim 4, wherein the third driving unit comprises,
an outer pipe having a hollow inside and a through hole formed through an outer circumferential surface;
an inner pipe movably insertable into the outer pipe; and
a motor controlling a direction and amount of movement of the inner pipe.

8. The head-mounted display of claim 7, wherein the outer pipe and the inner pipe are disposed in a longitudinal direction parallel to an optical axis of the pair of multi-channel lenses.

9. The head-mounted display of claim 7, wherein the motor controls a direction and amount of movement of the inner pipe according to whether a user wears glasses.

10. The head-mounted display of claim 4, wherein the fourth driving unit comprises,
an outer pipe having a hollow inside and a through hole formed through an outer circumferential surface;
an inner pipe movably insertable into the outer pipe; and
a motor for controlling a direction and an amount of movement of the inner pipe based on the pupil position information.

11. The head-mounted display of claim 10, wherein the outer pipe and the inner pipe of the fourth driving unit are disposed in a longitudinal direction perpendicular to an optical axis of the pair of multi-channel lens.

12. The head-mounted display of claim 1, wherein the pair of multi-channel lenses include a plurality of sub-lenses, and forms a path of light incident by each sub-lens for each of a plurality of channels.

13. A head-mounted display comprising:
a pair of frames for being worn on a user's body and corresponding to the user's eyeballs which include a left eye and a right eye;
a display unit including a pair of display panels respectively mounted to the pair of frames and a pair of multi-channel lenses disposed on a light output path of the pair of display panels; and
an eye tracking member disposed outside the pair of multi-channel lenses to obtain pupil position information about the user's pupil; and
a driving member connected to the pair of frames to tilt and/or move the frame in an up, down, left, and right direction,
wherein the driving member adjusts an up, down, left, and/or right alignment of a center of each of the user's eyeballs corresponding to a center of each of the pair of multi-channel lenses, adjusting an angle of the pair of multi-channel lenses, and adjusting a distance between the pair of multi-channel lenses and an eye of the user's eyeballs based on the pupil position information.

14. The head-mounted display of claim 13, wherein the eye tracking member comprises:
a light source disposed outside the pair of multi-channel lenses and disposed to be directed in a direction toward the user's eyeballs,
a camera or image sensor disposed outside the pair of multi-channel lenses and disposed to be directed in the direction of the user's eyeballs and detecting light emitted from the light source and reflected into the user's pupil.

15. The head-mounted display of claim 13, wherein the driving member comprises a first driving unit for adjusting a distance between the pair of display panels,
wherein the first driving unit comprises,
a pair of plates each fixed to the pair of frames and each having a long-shaped hole at one end directed in a longitudinal direction;
a rotation gear disposed within the long-shaped hole; and
a driving motor for rotating the rotation gear based on the pupil position information,
wherein the long-shaped hole is formed with a linear gear for meshing with the rotation gear on one side,
wherein the pair of plates is disposed such that each of the long-shaped holes overlaps at least a portion of each other.

16. The head-mounted display of claim 13, wherein the driving member comprises a second driving unit tilting a disposition direction of the pair of display panels about a central axis and adjusting a tilting angle of the pair of display panels,
wherein the second driving unit includes a motor controlling a tilting direction and a degree of tilting of the pair of display panels based on the pupil position information.

17. The head-mounted display of claim 13, wherein the driving member comprises a third driving unit for adjusting a distance between the pair of display panels and the user's pupil,
wherein the third driving unit comprises,
an outer pipe having a hollow inside and a through hole formed through an outer circumferential surface;
an inner pipe movably insertable into the outer pipe; and
a motor controlling a direction and amount of movement of the inner pipe.

18. The head-mounted display of claim 17, wherein the outer pipe and the inner pipe are disposed in a longitudinal direction which is parallel to an optical axis of the pair of multi-channel lenses.

19. The head-mounted display of claim 17, wherein the motor controls a direction and amount of movement of the inner pipe according to whether the user wears glasses.

20. The head-mounted display of claim 13, wherein the driving member comprises a fourth driving unit for vertically moving the pair of display panels,
wherein the fourth driving unit comprises,
an outer pipe having a hollow inside and a through hole formed through an outer circumferential surface;
an inner pipe movably insertable into the outer pipe; and
a motor for controlling a direction and an amount of movement of the inner pipe based on the pupil position information.

21. The head-mounted display of claim 20, wherein the outer pipe and the inner pipe of the fourth driving unit are disposed in a longitudinal direction which is perpendicular to an optical axis of the pair of multi-channel lenses.
